(19) United States
(12) Patent Application Publication
(10) Pub. No.: US 2007/0160807 A1
(43) Pub. Date: Jul. 12, 2007

(54) Grain-through flexible edgeband

(76) Inventors: Mark Kraus, Lovettsville, VA (US); Bruce Claridge, Cullman, AL (US)

Correspondence Address: MCGUIREWOODS, LLP, 1750 TYSONS BLVD, SUITE 1800, MCLEAN, VA, 22102, US

(21) Appl. No.: 11/209,838

(22) Filed: Aug. 24, 2005

Related U.S. Application Data
(60) Provisional application No. 60/603,632, filed on Aug. 24, 2004.

(51) Int. Cl. B32B 3/10

(52) U.S. Cl. 428/137; 428/192; 428/195.1; 428/151

(57) ABSTRACT

A flexible, grain-through edgeband (edgeband) having a swirl-type, or other type, pattern formed substantially throughout the thickness of the edgeband may be used to cover a portion of an edge of an object, such as a counter, a table, a shelf, or a furniture panel. The swirl-type, or other type, pattern may represent a simulated woodgrain or other effect, and may be visible when the edgeband is trimmed about flush with a top surface and/or a bottom surface of the object. The edgeband may be formed of a mixture of extruded or co-extruded materials having the same or different properties. Additionally, the edgeband may include a plasticizer in an amount sufficient to impart to the edgeband a flex modulus that enables the edgeband to be applied to concave or convex surfaces having radii of less than about ten (10) times the thickness of the edgeband.

### CROSS-REFERENCE TO RELATED APPLICATIONS

This application claims priority to and the benefit of U.S. Provisional Application Ser. No. 60/603,632 filed on Aug. 24, 2004, the contents of which are incorporated by reference herein in its entirety.

### BACKGROUND OF THE INVENTION

1. Field of the Invention

The invention generally relates to materials applied to unfinished edges of products to protect and cover the edge of the product in an aesthetically pleasing fashion, and, more particularly, to a flexible, grain-through edgeband that may be used to cover an edge of a object, such as a piece of furniture, a board, a panel, or other similar product, and a method for manufacturing the same.

2. Description of Related Art

Generally, a material commonly called edgeband may be applied to cover an edge of an object. An object may include virtually any hard surface. Examples of objects may include, but are not limited to, desks, tables, countertops, shelves, cabinets, boards, lockers, and storage devices. Often a woodgrain effect is desired on an edgeband surface to create a more attractive finished object and/or to match the pattern on the top or other surface of the object. The woodgrain effect may be a simulation of the actual appearance that would be achieved if wood, such as oak, cherry, mahogany, etc. was used to cover a side edge of the object. Typically in application the edgeband is adhered to the edge of the object, and the top surface and/or bottom surface of the object is covered with either a high pressure or low pressure laminate. In some instances, a paperbacking may be formed on a non-visible side of the laminate.

The outer, visible surface of the edgeband is typically printed or hot-stamped with a desired woodgrain pattern and/or color. When using edgeband thicker than about 1 mm, however, the application process creates a framing or halo effect around the object when the edgeband is trimmed, as shown schematically in the representation of FIG. 1. The framing (or halo) effect refers to the visible distinction between a pattern and/or color formed on at least the top surface 21 of the object 20 and the non-patterned and/or discolored top surface 11 of the edgeband 10 (i.e., the surface of the edgeband 10 that is about flush with the top surface of the object). The framing (or halo) effect is a direct consequence of the printed or stamped pattern being present only on the front surface 14 of the edgeband and not throughout its thickness T.

Of the two types of conventional edgebands (flexible and rigid), conventional production methods have produced a grain-through pattern throughout the thickness of the edgeband only for rigid edgeband. The grain-through pattern is evident on the cross-section of the edgeband that can be seen at the corners of the object. Conventional rigid edgeband, however, is not very flexible and cannot be applied around small radii, i.e., radii generally of less than about ten times the thickness of the edgeband, without cracking or breaking. This drawback dramatically limits the applications in which conventional rigid grain-through edgeband may be used.

On the other hand, the flexible edgeband enjoys a wider variety of applications because it can be flexed without cracking or breaking. Due to the nature of the materials used to form the flexible edgeband and the limitations of the methods used to manufacture the same, conventional flexible edgebands have not included a grain-through pattern. Consequently, the framing or halo effect may occur when a flexible edgeband is applied to an edge of an object.

Thus, a need exists for a flexible, grain-through edgeband that eliminates (or reduces) the framing or halo effect when installed along a side of an object, as well as for a flexible edgeband that is more flexible and can be applied about smaller radii than heretofore possible with rigid edgebands.

### SUMMARY OF THE INVENTION

The invention meets the foregoing needs and avoids the drawbacks and disadvantages of the prior art by providing a flexible, grain-through edgeband having a swirl-type, or other type, pattern substantially throughout at least a thickness of the edgeband that creates a predetermined visual effect. In one embodiment, the predetermined visual effect may be a simulated wood-grain pattern. Additionally, the invention provides a flexible, grain-through edgeband having a flex modulus that permits the flexible, grain-through edgeband to be applied about curved surfaces having radii that are less than about ten times the thickness of the flexible, grain-through edgeband.

Accordingly, in one aspect of the invention, a flexible edgeband for covering a side of an object is provided. The flexible edgeband has a thickness and a composition including a first material having a first property, a second material having a second property, and a pattern defining a predetermined visual effect. The pattern may be arranged substantially throughout the thickness of the flexible edgeband, and may be defined by mixture of the first and second materials in predetermined amounts.

In yet another aspect of the invention, a flexible edgeband for covering the side of an object has a pattern substantially throughout at least the thickness of the edgeband and is manufactured by a process that includes the steps of: extruding a first material having a first property into a die; adding a second material having a second property to the first material; and mixing the first and second materials to generate a pattern substantially throughout at least the thickness of the flexible edgeband. The first material may include at least one of polyvinyl chloride, a plasticizer, a secondary plasticizer/co-stabilizer, a mineral filler, a heat stabilizer, a color pigment, other additives, and combination thereof and said second material comprises one or more resins selected from the group consisting of ethylene vinyl chloride copolymers, ethylene-vinyl acetate (EVA) copolymers, styrene-acrylonitrile (SAN), acrylate-based styrene-acrylonitrile copolymers (ASA), ethyelene-vinylidene chloride copolymers, vinyl chloride-(meth)acrylic ester copolymers, vinyl chloride grafted polyurethane copolymers, methyl methaacrylate copolymers, nitrile rubber, acrylonitrile, acrylonitrile butadiene (NBR), cross-linked PVC, and a compound thereof. The extruding step may include extruding about 50% to about 70% by weight of the first material and the adding step may include adding up to about 20% by weight of the second material and further including the step of adding a compound selected from the group consisting of about 10% to about 20% by weight of a plasticizer, about 2% to about 10% by weight of a secondary plasticizer/co-stabilizer, up to about 30% by weight of a mineral filler about 1% to about 5% by weight of a heat stabilizer and up to about 2% by weight of another additive.

Additional features, advantages, and embodiments of the invention may be set forth in the following detailed description, drawings, and claims, including methods of manufacturing a flexible, grain-through edgeband, as well as methods of installing embodiments of the invention on an edge or edges of objects. Although numerous implementations and examples of the invention are set forth herein—including in this “Summary of Invention” section—the examples and implementations described herein are not intended to limit the scope of the invention.

### BRIEF DESCRIPTION OF THE DRAWINGS

The accompanying drawings, which are included to provide a further understanding of the invention and are incorporated in and constitute a part of this specification, illustrate preferred embodiments of the invention. Together with the detailed description, the drawings serve to explain the principles of the invention. No attempt is made to show structural details of the invention in more detail than may be necessary for a fundamental understanding of the invention and the various ways in which it may be practiced. In the drawings:

FIG. 1 is a perspective view of a conventional flexible, edgeband applied to a flat, side edge of a horizontally disposed object, schematically illustrating the halo-effect of the prior art;

FIG. 2 is an enlarged perspective view of a flexible, grain-through edgeband constructed according to the principles of the invention, applied to concave, convex, and flat portions of a side edge of a horizontally disposed object, such as but not limited to, a table, shelf, or countertop; and

FIG. 3 is a cross-sectional plan view of the flexible, grain-through edgeband of the invention schematically depicting an exemplary swirl type, or other type, pattern that may be formed throughout at least a thickness of the flexible, grain-through edgeband.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and manufacturing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals may represent similar parts throughout the several views of the drawings.

The figures herein illustrate various embodiments of a flexible, grain-through edgeband particularly adapted for use in the home furnishings, office furnishings, recreational vehicle furnishings, boat furnishings, aviation furnishings, automotive interiors, and related arts. The edges of the flexible, grain-through edgeband of the invention may display a swirl-type pattern that creates a simulated woodgrain effect. The flexible, grain-through edgeband may be formed of a mixture of extruded or co-extruded materials having the same or different properties to produce the desired visual effect. Illustratively, such materials may include polymers and polymer compounds. Additionally, the flexible, grain-through edgeband may include a plasticizer in an amount sufficient to impart to the edgeband a flex modulus that enables the edgeband to be applied without cracking or breaking to concave or convex surfaces having radii of less than about ten (10) times the thickness of the flexible, grain-through edgeband.

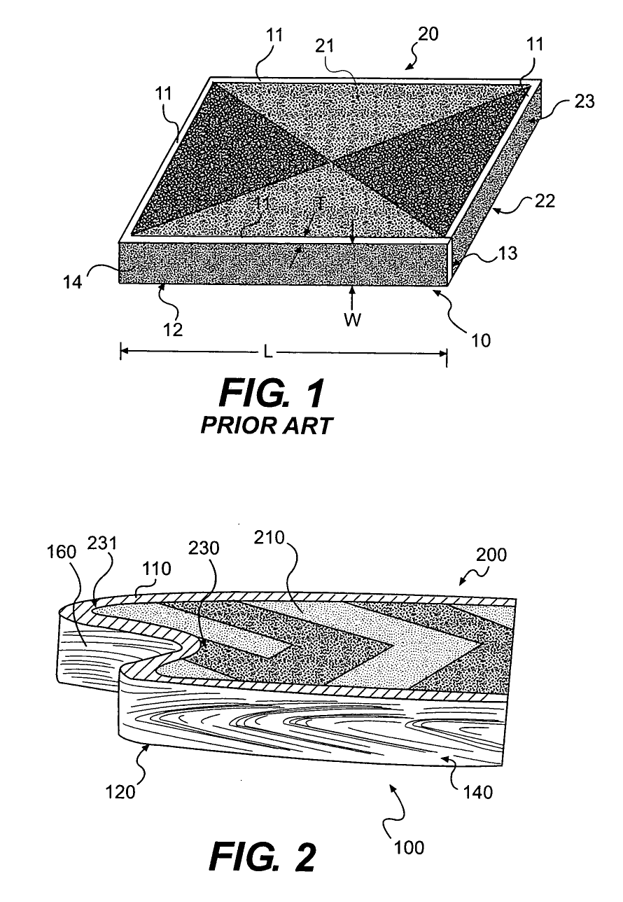

FIG. 1 is a perspective view of a conventional flexible edgeband 10 applied to the flat side portions of a horizontally disposed object 20. As mentioned above, the object 20 may be, but is not limited to, a tabletop, shelf, or countertop. The dimensions of the flexible edgeband 10 are depicted and described herein with respect to one side of the object, wherein a length L of the edgeband 10 extends horizontally across the side from left to right, wherein a width W of the edgeband 10 extends vertically from top to bottom, and wherein a thickness T of the edgeband 10 extends into the third dimension from front surface 14 to the back surface 13 (not visible in FIG. 1).

In FIG. 1, a portion of the object 20 has a planar configuration that includes a top surface 21, a bottom surface 22, and a side surface 23. The thickness of the object 20 is measured from its top surface 21 to its bottom surface 22 (not visible in FIG. 1). The top surface 21 of the object 20 may include one of a high pressure or a low pressure laminate, patterned to provide a desired visual effect, such as a simulated woodgrain pattern or other pattern schematically shown in FIG. 1.

The flexible, edgeband 10 is shown applied to the flat sides of the object 20. The flexible edgeband 10 has a top surface 11 of thickness T, a bottom surface 12 (not visible in FIG. 1), and a front surface 14 of length L, which represents the length of the flexible edgeband 10 along one side of the object. When the top surface 11 of the flexible edgeband 10 is trimmed about flush with the top surface 21 of the object 20 as known in the art, the top surface 11 forms a halo-type effect around the object because the material exposed across the thickness T of the flexible edgeband differs from the pattern on the top surface 21 of the object 20. As the front surface 14 of the flexible edgeband 10 is typically printed, stamped, and/or coated with a desired pattern and/or a protective topcoat, the exposed areas along thickness T may also differ from the front surface too.

FIG. 2 shows a flexible, grain-through edgeband 100 of the invention installed on curved but generally flat side portions of a portion of an object 200. The object 200 includes a top surface 210, a bottom surface (not shown), and a (circumferential) side disposed therebetween. Portions of the object 200's side are relatively flat, convex, and/or concave. Reference numeral 230 depicts a concave curved portion of the side, and while reference numeral 231 depicts a convex curved portion of the side.

As illustratively shown in FIG. 2, the top surface 210 may include a pattern. This pattern may have any desired color or shape, but is illustratively depicted here as a simulated in-laid wood pattern with alternating areas of dark and light colored wood. The pattern formed on the top surface 210 may be created either by a design printed on a high pressure or low pressure laminate adhered over a core substrate, by a (real wood or other) veneer applied over a core substrate, or by real wood (or other type of) pieces combined to form the object 200 itself.

The flexible, grain-through edgeband 100 is applied to the flat, concave, and/or convex side portions of the object 200 to (continuously) cover the edges in an aesthetically pleasing fashion. The flexible, grain-through edgeband 100 may be applied to flat or curved surfaces either by hand or by using a machine such as an edgebander. An edgebander is a device that routers, grooves, bores, applies and/or finishes the flexible, grain-through edgeband 100 to pre-fabricated objects. Examples of commercial grade, fully-automated edgebanders include the BAZ line of edgebanders manufactured by Homag, a manufacturer of machines for panel processing with headquarters in Schopfloch, Germany. Other types of edgebanders, however, may also be used to apply the flexible, grain-through edgeband 100 of the invention.

Additionally, an adhesive may be interposed between the back surface of the flexible, grain-through edgeband 100 and the curved and/or flat side edges of the object 200. Particular details of the installation process and/or the types of adhesive that can be used are not described herein as they will be readily apparent to the skilled artisan. Additionally, the flexible, grain-through edgeband 100 may be applied so that portions of the edgeband protrude past the top surface 210 of the object 200 and/or past the bottom surface (not visible) of the object 200. In particular, the flexible, grain-through edgeband 100 may overlap the top and/or bottom surfaces by about 3 mm to about 5 mm. Thereafter, the flexible, grain-through edgeband 100 may be trimmed such that its top surface 110 is about flush with the top surface 210 of the object 200, and such that its bottom surface 120 is about flush with the bottom surface (not visible) of the object 200. The trimming, which may be performed by hand or via a machine, reveals the material extending across the cross section of the thickness T of the edgeband, which forms the top surface 110 and is patterned according to the principles of the invention described herein.

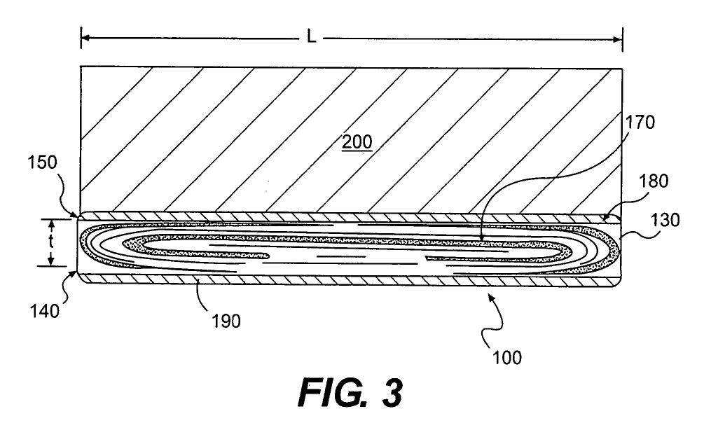

As illustratively depicted in FIG. 2, the trimmed top surface 110 of the flexible, grain-through edgeband 100 reveals a swirl type, or other type, pattern formed at least substantially throughout the thickness of the flexible, grain-through edgeband 100. The swirl-type, or other type, pattern may include any desired color. Another example is shown in FIG. 3. Other types of patterns, however, may also be used. This pattern is created as a result of mixing materials during an extrusion or co-extrusion process. The grain-through pattern is provided to eliminate (or reduce) the framing (or halo) effect associated with conventional flexible edgebands, by providing an aesthetically pleasing appearance along the edge (or about the circumference) of the top surface 210 of the object 200. Additionally, another pattern 160 may be printed onto the front surface 140 of the flexible, grain-through edgeband 100. The pattern 160 is illustratively depicted as a simulated woodgrain pattern, but any desired pattern may be provided. An exemplary process for forming the pattern 160 is further described below.

As explained in more detail below, the flexible, grain-through edgeband 100 includes a plasticizer in its makeup in an amount sufficient to provide a flex modulus that imparts to the flexible, grain-through edgeband 100 an ability to adhere to convex and/or concave surfaces having radii of less than about ten (10) times the thickness of the edgeband. Thus, in one embodiment, a 3 mm thick flexible, grain-through edgeband 100 may be applied to a concave surface or to a convex surface, such as 230, 231, each of which has about a 12 mm radius, which is only four (4) times the thickness of the edgeband. This is a significant improvement over conventional rigid edgebands, which typically can be applied only to curved surfaces having radii of at least about ten (10) times or greater than the thickness of the edgeband. Thus, while a conventional 3 mm thick rigid edgeband could be applied only to a curved surface having about a 30 mm radius without cracking or breaking, the flexible edgeband of the invention can be applied without cracking or breaking to a surface having a radius as low as about 12 mm or four (4) times its thickness. Thus, the improved flexibility of the flexible, grain-through edgeband 100 of the invention allows a wider design range for products that utilize edgebands, and allows designers to design objects with a wider range of convex and/or concave radii.

FIG. 3 is a cross-sectional plan view of the flexible, grain-through edgeband 100 of the invention, showing in greater detail an example of a grain-through pattern 170 formed substantially throughout the thickness T of the flexible, grain-through edgeband 100. FIG. 3 shows the flexible edgeband 100 of the invention applied to a side portion of object 200.

Referring to FIG. 3, a layer 180 that may include a primer and/or an adhesive is formed on the back surface 150 of the edgeband 100 and interposed between the back surface 150 and the side of the object 200. In FIG. 3, the side of the object 200 is depicted as being flat, but in other embodiments such as that depicted in FIG. 2, for example, the side of the object 200 may include flat, concave, and/or convex portions.

A decorative layer 190, that may include a printed pattern (160 in FIG. 2) and/or a protective topcoat, may be formed on the front surface 140 of the flexible, grain-through edgeband 100. The layer 190 may be applied to the front surface 140 using any suitable method, including but not limited to, printing or coating, and may include one or more sublayers. For example, a desired pattern may be printed onto the front surface of the edgeband 100. This sublayer may then be covered with a clear topcoat, which forms a second sublayer. The pattern formed by the layer 190 may be similar to or different from the pattern 170 that is formed substantially throughout the thickness T of the flexible, grain-through edgeband 100.

Exemplary materials comprising and methods for forming the flexible, grain-through edgeband 100 are now described.

The flexible, grain-through edgeband 100 of the invention may be formed from at least a polymer compound, such as, but not limited to, polyvinyl chloride (PVC). The improved flexibility of the flexible, grain-through edgeband 100 may be achieved by adding a plasticizer, such as but not limited to those described below, to the polymer compound. The addition of the plasticizer softens the polymer compound and reduces a durometer reading (e.g., reduces an initial Shore/Rockwell hardness of the polymer compound). The Shore test and the Rockwell hardness test measure the resistance of rubbers/plastics to indentation and provide an empirical hardness value. Of these two tests, the Shore test uses a durometer to determine hardness; and the hardness value is determined by how far the durometer indenter foot penetrates into a sample material.

In embodiments of the invention, the flexible, grain-through edgeband 100 may include any suitable polymer compound that includes at least one plasticizer in a proportion sufficient to achieve a desired flexible property of the flexible, grain-through edgeband 100, such as the flex modulus described above. Additionally, the polymer compound used to form the flexible, grain-through edgeband 100 of the invention may include various colors and in particular, woodgrain colors. For example, in one embodiment, the polymer compound may include PVC, a plasticizer, a secondary plasticizer/co-stabilizer, a mineral filler, a heat stabilizer, other additives, color pigments, and a combination thereof.

The polymer compound used to manufacture the flexible, grain-through edgeband 100 of the invention may include any polyvinyl chloride (PVC) or similar material that may be used for extrusion. Furthermore, the K-values of the PVC may range from about 60 to about 80. Periodically used as a resin specification in the United States, the K-value is a number calculated from dilute solution viscosity measurements of a polymer, used to denote degree of polymerization or molecular size. One formula that may be used to calculate a K-value is:

$$\frac{log ( {N}_{S} / {N}_{0} )}{c} = \frac{75 {K}^{2}}{1 + 1.5 Kc} + K$$

where

NS=viscosity of the solution

N0=viscosity of the solvent

c=concentration in grams per ml

In one embodiment, a polymer or a polymer compound may be blended with a second resin to improve the polymer's or the polymer compound's processability or other material properties. Illustratively, the polymer may be polyvinyl chloride (PVC) that is used in a range of about 50% to about 70% by weight in the resultant polymer compound.

The second resin may be one or more materials selected from ethylene vinyl chloride copolymers, ethylene-vinyl acetate (EVA) copolymers, styrene-acrylonitrile (SAN), acrylate-based styrene-acrylonitrile copolymers (ASA), ethyelene-vinylidene chloride copolymers, vinyl chloride-(meth)acrylic ester copolymers, vinyl chloride grafted polyurethane copolymers, methyl methaacrylate copolymers, nitrile rubber, acrylonitrile, acrylonitrile butadiene (NBR), cross-linked PVC, and a combination thereof. Additionally, the second resin may be used up to about 20% by weight in the resultant polymer compound.

The plasticizer of the invention may include plasticizers known to be usable with extrusion-grade PVC compatible resin. For example, the plasticizer may include any monomeric plasticizer such as phthalates (esters of phthalic acid). The phthalates may include, for example, DIHP (diisoheptyl phthalate), DIOP (diisooctyl phthalate), DOP/DEHP (di-2-ethylhexyl phthalate), DOTP (di-2-ethylhexyl phthalate with CAS number 137-89-3), DHP (dihexyl phthalate), DIDP (diisodecyl phthalate), 911P (linear C9C11 phthalate), DUP (diundecyl phthalate), esters of trimellitic acid such as TOTM (tri-2-ethylhexyl trimellitate. Alternatively, the plasticizer may include polymeric plasticizers such as sebacic acid (C10) polymerics (fatty-acid-terminated polyester), azelaic acid (C9) polymerics, adipic acid (C6) polymerics, and glutaric acid (C5) polymerics. Depending on the desired hardness and/or flexibility properties of the edgeband, the plasticizer may be used in an amount in a range of about 5% to about 40% by weight. More specifically, the plasticizer may be used in an amount in a range of about 10% to about 20% by weight in the resultant polymer compound.

In another embodiment, a secondary plasticizer/co-stabilizer in the polymer compound may also be used. The secondary plasticizer may be ESO (epoxidized soybean oil), for example. The secondary plasticizer/co-stabilizer may be used in an amount in a range of about 2% to about 10% by weight in the resultant polymer compound.

In another embodiment, the polymer compound may further include a mineral filler. The mineral filler may include calcium carbonate (CaCO₃), magnesium hydroxycarbonate, and may be surface-treated (stearic acid) or non-treated, for example. The mineral filler may be used in an amount in a range of about 0% to about 30% by weight in the resultant polymer compound.

In yet another embodiment, the polymer compound may also include heat stabilizers. The stabilizers may be one or more of commercially available metal salts, organometallic salts or soaps, or organometallic compounds that are known in the art of polyvinyl chloride stabilizers. For example, examples of suitable stabilizers for use in the invention include mixed metal salts such as barium/zinc (such as BAEROSTAB™ UBZ 791 from Baerlocher of Unterschleissheim, Germany), calcium/zinc (such as STABIOL CZ 2001/1 from Cognis of Düsseldorf, Germany), organotin stabilizers (either methyl tin, or ethyl tin, or propyl tin, or butyl tin, such as ADVASTAB TM-181 from Rhom & Haas of Philadelphia, Pa., MARK 17M from Crompton Corporation of Middlebury, Conn.). The heat stabilizer may be used in an amount in a range of about 1% to about 5% by weight. More specifically, the heat stabilizer may be used in amount in a range of about 2% to about 3% by weight in the resultant polymer compound.

The polymer compound of the invention may further include one or more other additives if necessary. Each additive should be used in an amount that does not adversely affect the performance of the obtained polymer compound or the desired swirling effects of the polymer compound. Each additive should be used in an amount that improves the processability and performance of the polymer compound. Each additive may include one or more of lubricants such high molecular weight complex ester, fatty acid ester, stearic acid ester, antioxidants, ultraviolet absorbers, fire retardants, and a combination thereof. An additive (or additives) may be used in an (aggregate) amount in the range of about 0% to about 2% by weight in the resultant polymer compound.

In another embodiment of the invention, the process stability of the PVC compound may be further enhanced by adding an acid scavenger such as zeolite based acid absorber. Additionally, color pigments may be added as necessary to the polymer compound.

The polymer compound of the invention may be manufactured by utilizing a co-extrusion or similar process. For example, a first material may be extruded from a first extruder, and a second material may be extruded from a second extruder. The first and second material may be different materials or the same material but with different characteristics or properties, such as color. The extruders may be positioned so that the first material and the second material are joined together just before or as they enter a die.

The two materials may be the same or different materials having different colors that are uniquely chosen to compliment the desired effect on the surface of the flexible, grain-through edgeband, such as a woodgrain effect. The two materials may be mixed together, at approximately a 60/40 by weight mix, in a swirl-type, or other type, pattern. This swirl effect may be used to create a simulated, random woodgrain effect substantially throughout the thickness of the flexible, grain-through edgeband. The simulated, random woodgrain effect should remain visible along at least the top surface of the flexible, grain-through edgeband even after the edgeband is trimmed during the installation process. The two materials should achieve the swirl effect (in the die) while maintaining their unique, individual color without over mixing or overblending, which may cause the contrast to fade and thus reduce the effect of the grain-through process.

Once mixed, the swirled materials are extruded through the die. Once the extruded swirled mixture exits the die, it may be subjected to a calibration process that includes exposure to a vacuum environment to size the flexible, grain-through edgeband 100 to the proper dimensions. After calibration, the flexible, grain-through edgeband 100 may be passed through a series of water baths and spray tanks for cooling. A primer may then be applied to the backside of the flexible, grain-through edgeband 100. The primer may function as a bonding agent between the flexible, grain-through edgeband 100 and the glue or other adhesive that may be utilized in the application process.

The front surface of the edgeband may have a woodgrain pattern or other visual effect applied downstream of the extrusion line. For example, the woodgrain pattern or other visual effect may be applied to the flexible, grain-through edgeband 100 using a series of print stations. Each print station may apply a layer of ink in a unique pattern that may vary from station to station depending on the configuration of an application wheel used at each station. Each application wheel may rotate to deposit its inked pattern on the front surface of the flexible, grain-through edgeband 100. Thus, the front surface's final appearance may be achieved by combining one or more unique patterns that are applied in the series of print stations. Finally, a clear topcoat may be applied over the woodgrain pattern.

Before a flexible, grain-through edgeband 100 is installed on an edge of a object, an adhesive, such as glue, may be applied to a backside surface of the flexible, grain-through edgeband or directly to an object to which the flexible, grain-through edgeband will be adhered. Subsequently, the flexible, grain-through edgeband may be adhered to the object using a series of pressure rollers that press the flexible, grain-through edgeband against the adhesive. Generally, proper care must be taken in these stages to ensure that the edgeband and/or the adhesive properly adhere to a portion of the object. In particular, adhesive temperature and the amount of adhesive applied to the edgeband may be critical and should be monitored according to the manufacturer's recommendations.

Once the edgeband has been adhered to a portion of the object such as a side, the edgeband may then be trimmed or routed down to about the width of the portion as previously described. This trimming may be achieved through a sequence of steps including a rough cut step, a fine cut step, and finally a scrapping step. The number of trim steps required, however, may vary by individual preference and application. Once the flexible, grain-through edgeband 100 has been trimmed, the grain-through effect should be visible on at least the top surface or bottom surface of the flexible, grain-through edgeband 100.

While the invention has been described in terms of exemplary embodiments, those skilled in the art will recognize that the invention can be practiced with modifications in the spirit and scope of the appended claims. The examples given above are merely illustrative and are not meant to be an exhaustive list of all possible designs, embodiments, applications or modifications of the invention. For example, description and depiction of the flexible, grain-through edgeband of the invention with respect to a vertical frame of reference is not shown so as not to complicate the invention unnecessarily. It is, however, contemplated that the flexible, grain-through edgeband of the invention may be applied to vertical surfaces, such as the front edges of a vertically aligned portion of an object, e.g. a bookshelf, whose (vertical) height may be greater than its (horizontal) width.

What is claimed is:

1. A flexible edgeband for covering an edge of an object, said flexible edgeband having a thickness and a composition comprising:
a first material having a first property;
a second material having a second property; and
a pattern defining a predetermined visual effect arranged substantially throughout the thickness of said flexible edgeband, said pattern being defined by mixture of said first and second materials in predetermined amounts.

2. The flexible edgeband of claim 1, wherein said pattern is also formed substantially throughout a length of said flexible edgeband.

3. The flexible edgeband of claim 1, wherein said pattern appears on at least one of a top surface and a front surface of said flexible edgeband.

4. The flexible edgeband of claim 1, wherein said top surface of said edgeband is formed by cutting away a portion of the edgeband to reveal said pattern.

5. The flexible edgeband of claim 1, wherein said pattern comprises a swirl pattern.

6. The flexible edgeband of claim 1, wherein said pattern is one of a substantially uniform pattern and a substantially non-uniform pattern.

7. The flexible edgeband of claim 1, wherein said predetermined visual effect is a simulated woodgrain pattern.

8. The flexible edgeband of claim 1, wherein said first and second materials are different.

9. The flexible edgeband of claim 1, wherein said first and second materials are the same, and the first and second properties are different.

10. The flexible edgeband of claim 1, wherein the first and the second properties are selected from the group consisting of density, melt-viscosity, color, K-value, melt-characteristic, setting shrinkage, flex modulus, durometer hardness, shear rate, and a combination thereof.

11. The flexible edgeband of claim 1, wherein the first and second properties are the same, and the weights of the first and second materials used in the composition are different.

12. The flexible edgeband of claim 1, wherein the first and second properties are different.

13. The flexible edgeband of claim 1, wherein said first material has a weight in a range of about 50% to about 70% of a total weight of the composition, and said second material has a weight in a range of about 20% of the total weight of the composition.

14. The flexible edgeband of claim 1, wherein at least one of said first and second materials comprises polyvinyl-chloride (PVC).

15. The flexible edgeband of claim 14, wherein said second material comprises one or more resins selected from the group consisting of ethylene vinyl chloride copolymers, ethylene-vinyl acetate (EVA) copolymers, styrene-acrylonitrile (SAN), acrylate-based styrene-acrylonitrile copolymers (ASA), ethyelene-vinylidene chloride copolymers, vinyl chloride-(meth)acrylic ester copolymers, vinyl chloride grafted polyurethane copolymers, methyl methaacrylate copolymers, nitrile rubber, acrylonitrile, acrylonitrile butadiene (NBR), cross-linked PVC, and a combination thereof.

16. The flexible edgeband of claim 1, wherein said composition further comprises one or more compounds selected from the group consisting of a plasticizer, a secondary plasticizer/co-stabilizer, a mineral filler, a heat stabilizer, a color pigment, other additive, and a combination thereof.

17. The flexible edgeband of claim 16, wherein the weight of said plasticizer is in a range of about 10% to about 20% of a total weight of said composition.

18. The flexible edgeband of claim 17, wherein said plasticizer is a monomeric plasticizer selected from the group consisting of phthalates (esters of phthalic acid) and esters of trimellitic acid.

19. The flexible edgeband of claim 17, wherein said plasticizer is one or more monomeric plasticizers selected from the group consisting of DIHP (diisoheptyl phthalate), DIOP (diisooctyl phthalate), DOP/DEHP (di-2-ethylhexyl phthalate), DOTP (di-2-ethylhexyl phthalate with CAS number 137-89-3), DHP (dihexyl phthalate), DIDP (diisodecyl phthalate), 911P (linear C9C11 phthalate), DUP (diundecyl phthalate), TOTM (tri-2-ethylhexyl trimellitate), and a combination thereof.

20. The flexible edgeband of claim 17, wherein said plasticizer is one or more polymeric plasticizers selected from the group consisting of sebacic acid (C10) polymerics (fatty-acid-terminated polyester), azelaic acid (C9) polymerics, adipic acid (C6) polymerics, glutaric acid (C5) polymerics, and a combination thereof.

21. The flexible edgeband of claim 16, wherein said mineral filler has a weight in a range of about 10% to about 30% of the total weight of the composition and comprises a material selected from the group consisting of calcium carbonate (CaCO₃) and magnesium hydroxycarbonate.

22. The flexible edgeband of claim 16, wherein said heat stabilizer has a weight of in a range of about 1% to about 5% of the total weight of said composition and comprises one or more polyvinyl chloride stabilizers selected from the group consisting of metal salts, calcium/zinc, organotin stabilizers, organometallic salts, organometallic soaps, organometallic compounds, and a combination thereof.

23. The flexible edgeband of claim 16, wherein said additive has a weight in a range of about 0% to about 2% of a total weight of said composition, and comprises one or more compounds selected from the group consisting of a high molecular weight complex ester, a fatty acid ester, a stearic acid ester, an antioxidant, an ultraviolet absorber, a fire retardant, and a combination thereof.

24. The flexible edgeband of claim 1, further comprising a finish having predetermined visual effect applied to a front surface of said edgeband.

25. The flexible edgeband of claim 24, wherein said predetermined visual effect is a simulated woodgrain effect.

26. The flexible edgeband of claim 1, wherein said first and second materials and properties are selected to enable the flexible edgeband to be applied to a curved surface of an object having a radius less than about ten (10) times the thickness of said edgeband.

27. The flexible edgeband of claim 26, wherein the radius is less than about four (4) times to about ten (10) times the thickness of said edgeband.

28. The combination of the flexible edgeband of claim 26 and an object having a curved surface to which the flexible edgeband is adhered, said curved surface having a radius less than about ten (10) times the thickness of the flexible edgeband.

29. A flexible edgeband for covering the edge of an object, said flexible edgeband having a pattern substantially throughout at least the thickness of the edgeband, said flexible edgeband manufactured by the process comprising the steps of:
extruding a first material having a first property into a die;
adding a second material having a second property to the first material; and
mixing the first and second materials to generate a pattern substantially throughout at least the thickness of said flexible edgeband.

30. The flexible edgeband of claim 29, wherein the second material is added in a co-extrusion process.

31. The flexible edgeband of claim 29, wherein the first material comprises at least one of polyvinyl chloride, a plasticizer, a secondary plasticizer/co-stabilizer, a mineral filler, a heat stabilizer, a color pigment, other additives, and combination thereof and said second material comprises one or more resins selected from the group consisting of ethylene vinyl chloride copolymers, ethylene-vinyl acetate (EVA) copolymers, styrene-acrylonitrile (SAN), acrylate-based styrene-acrylonitrile copolymers (ASA), ethyelene-vinylidene chloride copolymers, vinyl chloride-(meth)acrylic ester copolymers, vinyl chloride grafted polyurethane copolymers, methyl methaacrylate copolymers, nitrile rubber, acrylonitrile, acrylonitrile butadiene (NBR), cross-linked PVC, and a compound thereof.

32. The flexible edgeband of claim 29, wherein said first and second materials are the same.

33. The flexible edgeband of claim 29, wherein said first and second materials are different.

34. The flexible edgeband of claim 29, wherein the first and second properties are the same.

35. The flexible edgeband of claim 29, wherein the first and second properties are different.

36. The flexible edgeband of claim 29, wherein said extruding step comprises extruding about 50% to about 70% by weight of said first material and said adding step comprises adding up to about 20% by weight of said second material and further comprising the step of adding a compound selected from the group consisting of about 10% to about 20% by weight of a plasticizer, about 2% to about 10% by weight of a secondary plasticizer/co-stabilizer, up to about 30% by weight of a mineral filler about 1% to about 5% by weight of a heat stabilizer and up to about 2% by weight of another additive.
